(19) United States
(12) Patent Application Publication
(10) Pub. No.: US 2009/0011825 A1
(43) Pub. Date: Jan. 8, 2009

(54) Persistent Notification and Common Display of Shares in a Community Electronic Video Card Game

(75) Inventors: Gregory J. Lima, Westport, MA (US); John W. Asermely, Westport, MA (US)

Correspondence Address: COURTNEY STANIFORD & GREGORY LLP, P.O. BOX 9686, SAN JOSE, CA, 95157, US

(73) Assignee: GLOBAL VR, San Jose, CA (US)

(21) Appl. No.: 12/115,499

(22) Filed: May 5, 2008

Related U.S. Application Data
(60) Provisional application No. 60/927,277, filed on May 3, 2007.

(51) Int. Cl. G06F 17/00

(52) U.S. Cl. 463/27; 463/42

(57) ABSTRACT

Embodiments described herein are directed to the persistent and common display of shared progressive jackpot data in a community electronic video poker game. In an embodiment, the video game is a poker game that combines traditional draw poker games with bonus games that include aspects of puzzle games. Successful completion of one or more bonus games qualifies the user to enter into a community game that allows the user to play against other players through a series of poker rounds and/or puzzle solving rounds. The community game features a shared progressive jackpot that pays out to the players on the basis of one or more winning events. The values and relevant parameters related to the shared jackpot are displayed to all qualified participating players through a common display device or an identical display window on each player game console. A persistent notification process updates the jackpot value and share notification on a defined periodic basis.

### CROSS-REFERENCE TO RELATED APPLICATIONS

This application claims priority from U.S. Provisional Patent Application No. 60/927,277, entitled “Puzzle Poker”, filed May 3, 2007, which is incorporated by reference in its entirety herein. This application is related to U.S. patent application Ser. No. 12/115,470, entitled “Puzzle Poker Electronic Video Card Game”, filed May 5, 2008, which is incorporated by reference in its entirety herein.

### TECHNICAL FIELD

Embodiments described herein relate generally to interactive entertainment systems, and more specifically to shared or community electronic video card games.

### BACKGROUND

Electronic card games, such as electronic poker have become a well established mainstay in casinos and gaming establishments around the world, and the advent of the Internet has given rise to many online versions of these games. The popularity of electronic or online poker has led to a significant rise in popular interest for the game in both the traditional, card-based format and the electronic, computer-based format. Many video and other similar electronic games are played in a networked environment in which groups of players play against one another through individual game consoles. The game consoles are typically configured to display the same game on each of the consoles. In this manner a virtual common game is set up in which each player participates in a common game from their own game console. The game can be displayed on a common display, such as a big-screen monitor that is visible to all of the players from a central location, or it can be through a window or dedicated display on each individual game console.

In general, the implementation of social card games and other interactive games played by a number of users against one another in networked computer environments has greatly enhanced playability for players who may unable to get together and play in the same place, and at the same time. However, such network implementations typically only provide a communication medium through which remote players can communicate with one another and play the same game. As such, they typically do not facilitate the implementation of shared jackpots, which are popular in many casino environments. Thus, present networked game systems do not advantageously enable the implementation of shared progressive jackpots among a plurality of users.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an electronic game screen for an online puzzle poker game, according to an embodiment.

FIG. 2 illustrates the display of an online puzzle poker game with dealt cards, under an embodiment.

FIG. 3 illustrates a puzzle poker bonus game under an embodiment.

FIG. 4 illustrates a fillable puzzle bonus game that is part of the puzzle poker game, under an embodiment.

FIG. 5 illustrates the display of the bonus puzzle in conjunction with a poker hand of a puzzle poker game, under an embodiment.

FIG. 6 illustrates a bonus game for the puzzle poker system, under an alternative embodiment.

FIG. 7 illustrates the bonus game of FIG. 6 with three example winning poker hands, in an embodiment.

FIG. 8 illustrates the bonus game of FIG. 6 in which poker hands are arranged in the shapes of 5 squared puzzle pieces, in an embodiment.

FIG. 9 illustrates the display of a community progressive puzzle game, under an embodiment.

FIG. 10 illustrates the display of a shared progressive jackpot for a puzzle poker game, under an embodiment.

FIG. 11 illustrates a qualification display screen for a community puzzle of a puzzle poker game, under an embodiment.

FIG. 12 is a flowchart that illustrates the process of participating in a community game, according to an embodiment

FIG. 13 illustrates a console-based gaming system for implementing a community puzzle poker game, under an embodiment.

### DETAILED DESCRIPTION

Embodiments described herein are directed to the persistent and common display of shared progressive jackpot data in a community electronic video poker game. In one embodiment, the video game is a poker game that combines traditional draw poker games with bonus games that include aspects of puzzle games. Successful completion of one or more bonus games qualifies the user to enter into a community game that allows the user to play against other players through a series of poker rounds and/or puzzle solving rounds. The community game features a shared progressive jackpot that pays out to the players on the basis of one or more winning events. The values and relevant parameters related to the shared jackpot are displayed to all qualified participating players through a common display device or an identical display window on each player game console. A persistent notification process updates the jackpot value and share notification on a defined periodic basis.

In the following description, numerous specific details are introduced to provide a thorough understanding of, and enabling description for, embodiments of the online puzzle poker game and game system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

Embodiments of the puzzle poker game are played on an electronic game console or computer (hereinafter referred to as the “game platform” or the “game console”) that includes a central processing unit and a display, along with other components, such as memory, input/output devices, network access devices, and so on. A graphical user interface provides the game environment for the user and may be provided on a single display device, or multiple display devices including a display that is visible to multiple users at one time. A network of game consoles supporting respective players of the puzzle poker game may be referred to as the “puzzle poker system.”

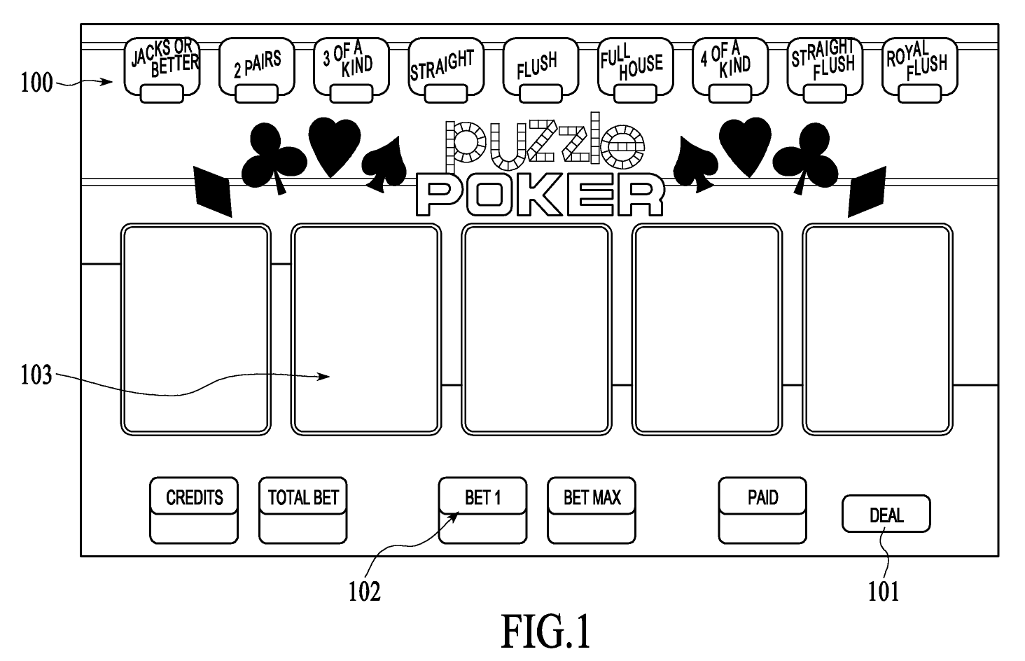

FIG. 1 illustrates an electronic game screen for an online or electronic puzzle poker game, according to an embodiment. This is the basic screen of the graphical user interface before a player begins a game. A paytable 100 is displayed along the top of the screen. The paytable indicates the payout for various poker hands, such as a royal flush, a straight flush, etc, and appear in the blank boxes beneath the name of each hand. The screen is configurable to display any desired predetermined payouts for each respective hand. The player begins a hand by making a bet, which is placed by entering an amount in the “bet 1” box 102. The amount can be in any appropriate denomination, such as money (of any currency), credits, chips, or any similar defined unit of value. The paytable is then filled dynamically with predetermined amounts and cards are dealt into the card display spaces 103. The number of card spaces corresponds to the type of card game being played, 5-card stud, 7-card stud, and so on. The player then presses the “deal” button 101, and a hand of cards are dealt into the card display spaces 103. The number of card spaces for the hand corresponds to the type of card game being played, 5-card stud, 7-card stud, and so on. After the hand is dealt the “deal” button 101 turns into a “draw” button for draw poker games.

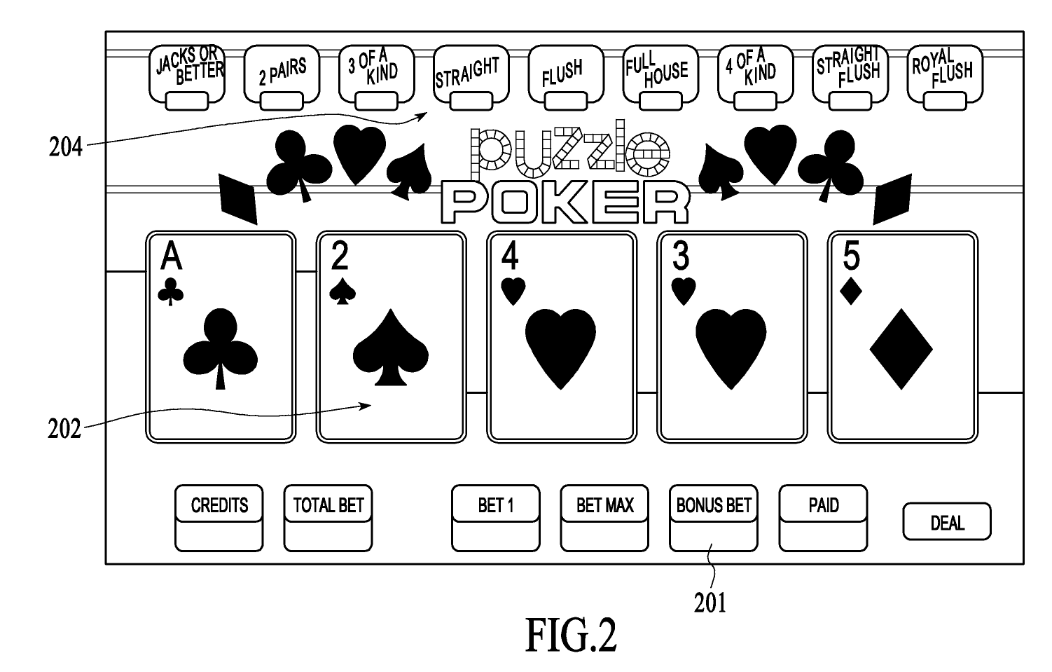

FIG. 2 illustrates the display of an online puzzle poker game with dealt cards, under an embodiment. The layout of the interface screen may be configured in any number of ways, depending upon actual implementation based on system constraints and requirements. After the deal, the player holds the cards or presses a draw button to exchange a number of cards. The player can then compare their hand against the pay schedule displayed in the paytable 100. For the example shown in FIG. 2, the dealt hand 202 is a straight so the payout corresponds to the amount shown in box 204. Although examples are shown in relation to a particular type of poker game, e.g., 5-card stud poker, it should be understood that any type of poker game that is suitable for computer implementation may be implemented. Furthermore, any suitable variation of such a game is possible. For example, the game could be “jacks or better” in which payoffs begin at a pair of jacks or better, or it could be “deuces wild”, “tens or better”, “three of a kind”, or any other variation with suitable wild cards defined. The mechanics of the betting, draw, and payout processes for each hand of poker may be implemented as known in present versions of electronic poker systems.

The embodiment of FIG. 2 illustrates an interface that provides access to a bonus game. The “bonus bet” button 201 allows the user to access a puzzle poker bonus game and a community game in which a number of players participate and progressive payouts are shared among the community of players.

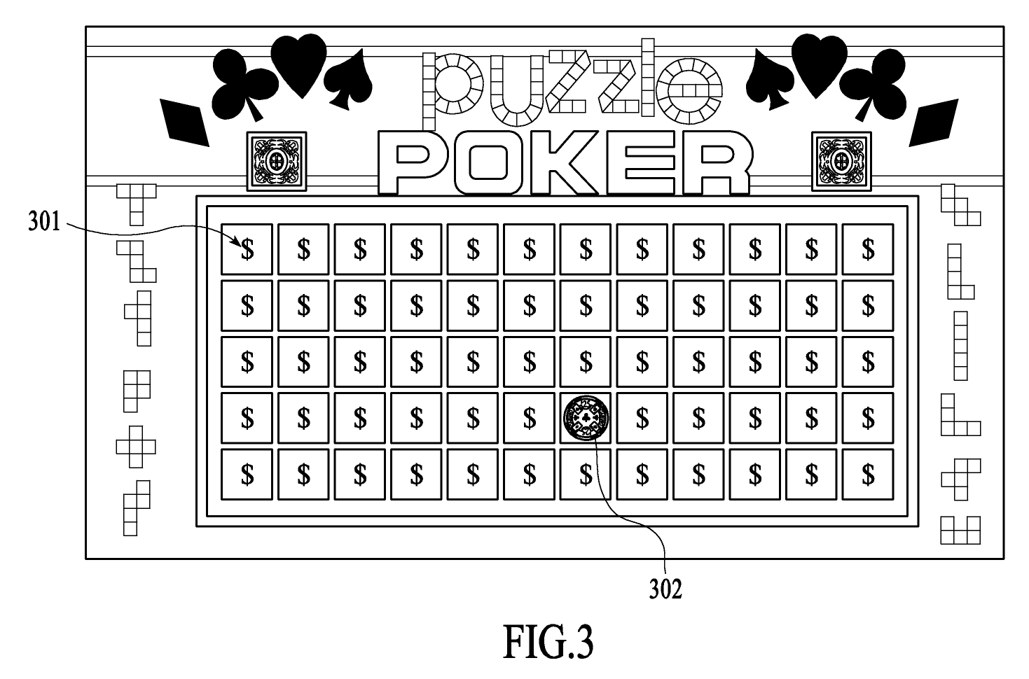

In one embodiment, the puzzle poker bonus game comprises a virtual puzzle that must be filled in or solved by the user. The bonus game appears randomly upon the completion of a hand. In one embodiment, the bonus game consists of an array of selectable blocks that hide prizes. If the player selects the appropriate block or blocks within the array, he or she then wins a bonus prize. FIG. 3 illustrates a puzzle poker bonus game under an embodiment. As shown in FIG. 3, an array of blocks 301 is displayed. Unselected boxes are denoted with a $ sign. The player can then select one or more blocks. Uncovering a block may result in the display of a prize or have no effect. The bonus game is played until three losing blocks are selected. A losing block is denoted as a black poker chip, or a similar symbol. In an embodiment, one of the losing black poker chips is represented as black with multi-colored checkers. Selecting this chip sends a block to the community puzzle game where the prizes are distributed. Alternatively, the “losing” block may instead be represented as a “winning” block. In one embodiment, the player places a bet prior to selecting a block in the bonus game. In an alternative embodiment, no bet is needed to select a block in the bonus game.

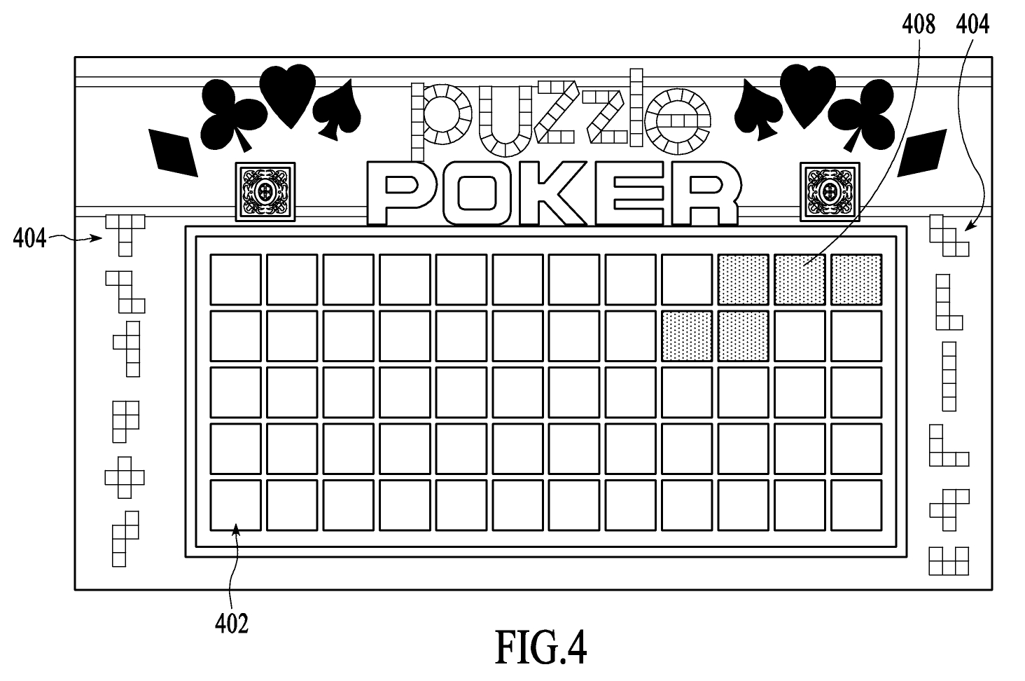

The bonus game may also be implemented as a fillable puzzle. FIG. 4 illustrates a fillable puzzle bonus game that is part of the puzzle poker game, under an embodiment. The puzzle consists of an array 402 of 60 squares laid out as a series of columns and rows, such as the 5×12 array shown in FIG. 4, although other array configurations are possible. A number (e.g., 12) of five-square puzzle pieces (pentiminos) 404 are provided to fill in the array. As can be seen in FIG. 4, any number of different arrangements of the 12 different puzzle pieces can be produced to partially or fully fill in the entire array 402. Piece 408 illustrates the example placement of one piece in the array 402. The bonus game is won when the array is entirely filled with 12 of the puzzle pieces. When the user is dealt a winning hand in a poker game, they will earn one of the twelve pieces 404 to place on the board. In one embodiment, the piece is selected by the user and automatically placed in the array. The automatic placement is optimized to fill the entire array as quickly as possible. Alternatively, the user must select and place the piece himself. The example of FIG. 4 has 60 square pentiminos, which gives 1010 total puzzle combinations, but it should be noted that many different puzzle arrangements can be used depending upon system constraints and gaming environments.

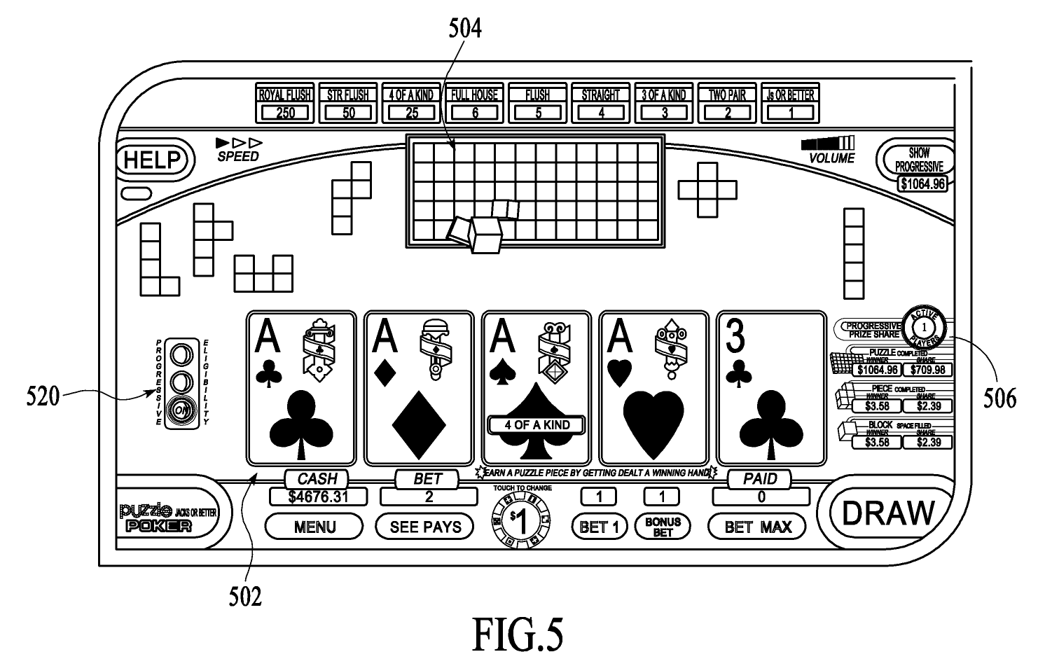

FIG. 5 illustrates the display of the bonus puzzle in conjunction with a poker hand of a puzzle poker game, under an embodiment. As can be seen in FIG. 5, the dealt hand 502 has four aces, which is a winning hand that results in the placement of a puzzle piece in the puzzle array. In one embodiment, a player can only gain a piece if he or she is dealt a winning hand. Alternatively, the player may get a puzzle piece if he or she wins after drawing a winning hand. A window 504 in the display shows the bonus game (or community game) in conjunction with the poker hand.

Various different types of games can be implemented as the bonus game. For example, the bonus puzzle game may be any type of puzzle game, such as a jigsaw puzzle of predefined shapes, a world map, or any similar fill in the blanks type of game. Alternatively, it can be a game with different fillable elements, such as bingo, keno ball, roulette, and so on.

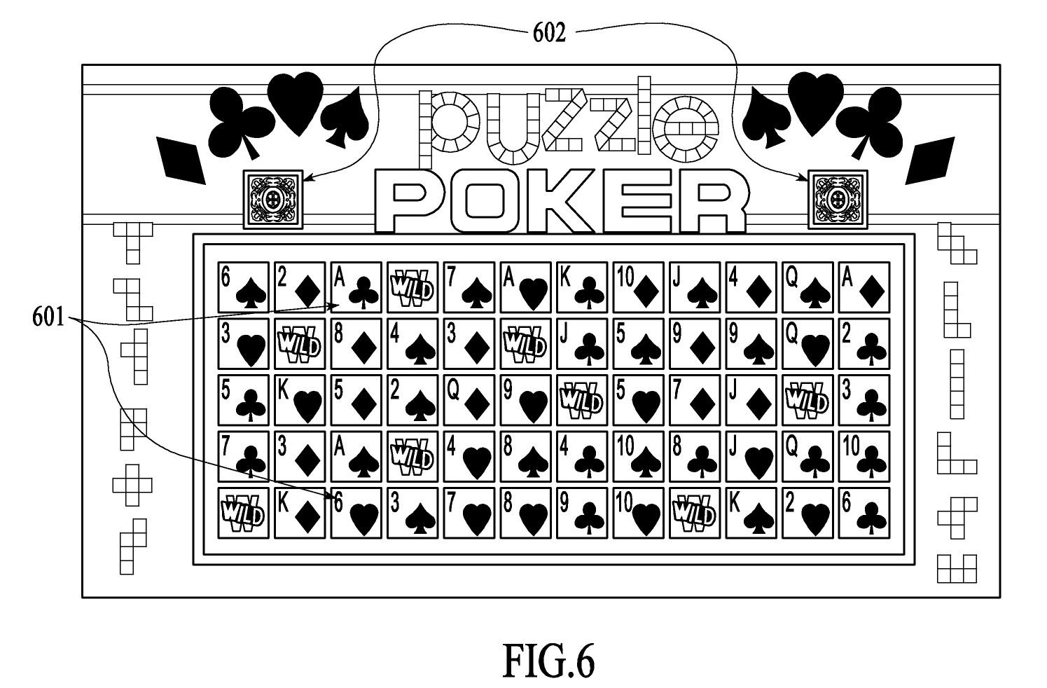

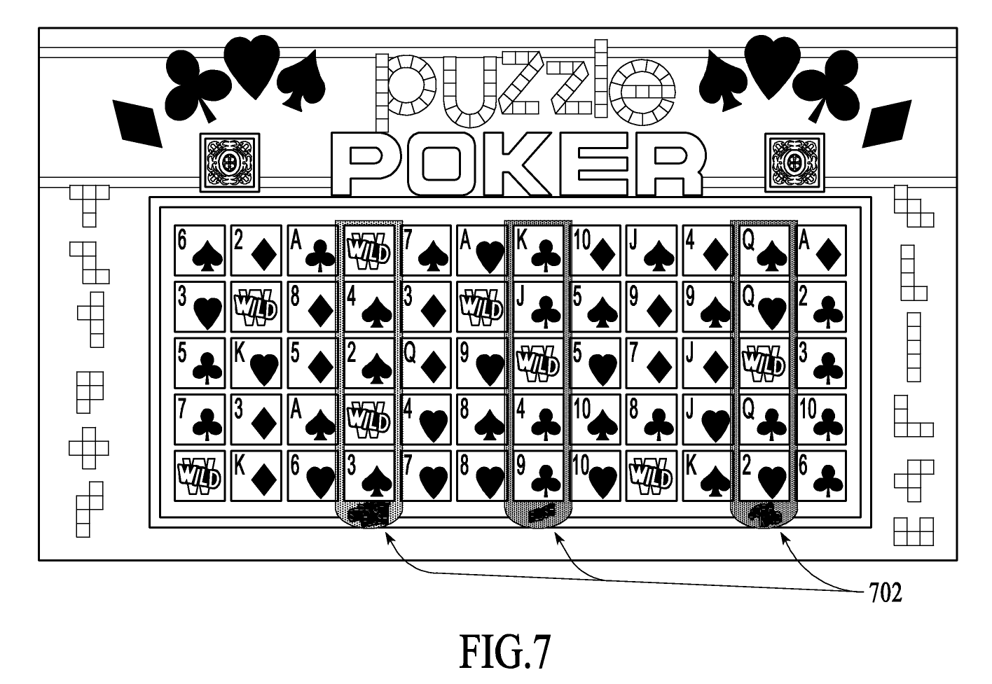

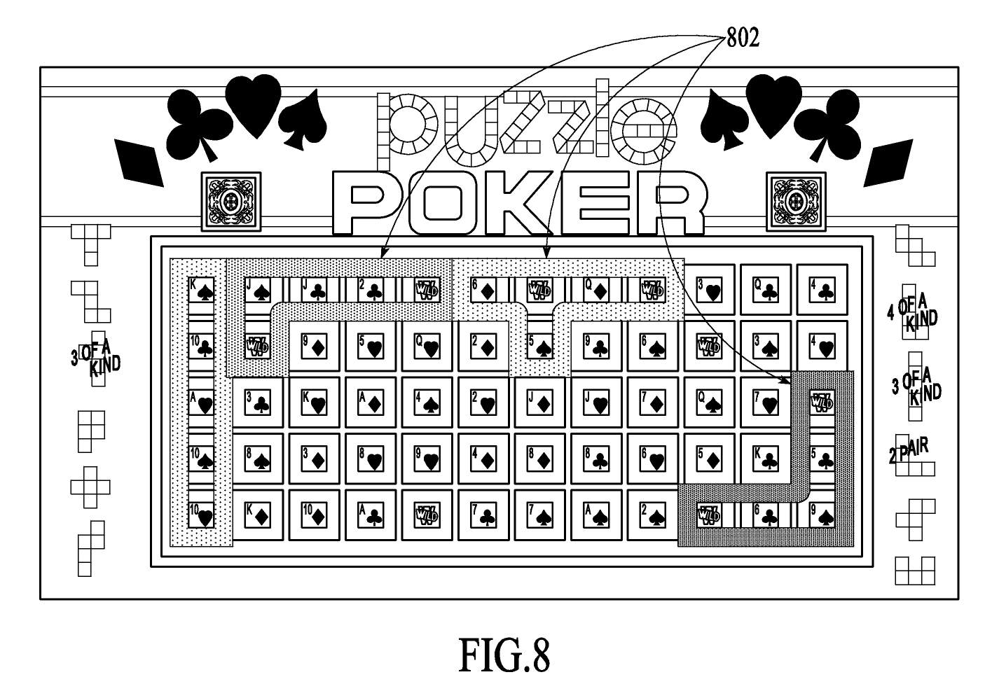

In an alternative embodiment the bonus game utilizes a 60 card deck (a standard 52 card deck plus 8 wild cards) to fill the 60 squares of the puzzle array. The system randomly deals cards out to fill the 60 puzzle squares of the array. FIG. 6 illustrates a bonus game for the puzzle poker system, in which a number of different poker hands are dealt and played simultaneously in a 60-square array. For this embodiment, the player can win up to 12 times either horizontally or vertically (depending on screen layout) in the bonus game with a winning 5 card stud poker hand of jacks or better. As shown in FIG. 6, squares 601 are filled with cards from the 60-card deck 602. For the five row-by-twelve column layout shown in FIG. 6, each column of five cards comprises a single hand. Bonus game payouts are won vertically with each winning 5 card poker hand, as shown in FIG. 7 in which hands 702 are winning hands in a jacks-or-better 5 card stud game. For a screen layout that is twelve row-by-five column, each row of five cards would comprise a single hand. The player can also win up to 12 times in the shapes of 5 squared puzzle pieces with a winning 5 card stud poker hand of jacks or better. This configuration is illustrated in FIG. 8 in which bonus game payouts are won in the shapes of the puzzle pieces with winning 5 card poker hands 802.

The poker and bonus games illustrated in FIGS. 2-8 are typically single player games in which the player plays individually and bets and wins against the machine. In an embodiment, the puzzle poker game is linked to a community game in which two or more players participate. The community game is essentially an extra bonus game that is accessible to the player after he or she wins a requisite number of poker and/or bonus game rounds. In one embodiment, certain aspects of the individual game may carry over to the community game, such as puzzle pieces, prize winnings, and the like. The community game may be a puzzle or any type of multi-player game that allows participation and payouts to multiple players. For purposes of the present description, the community game will be described in relation to a community puzzle game, although other games are possible.

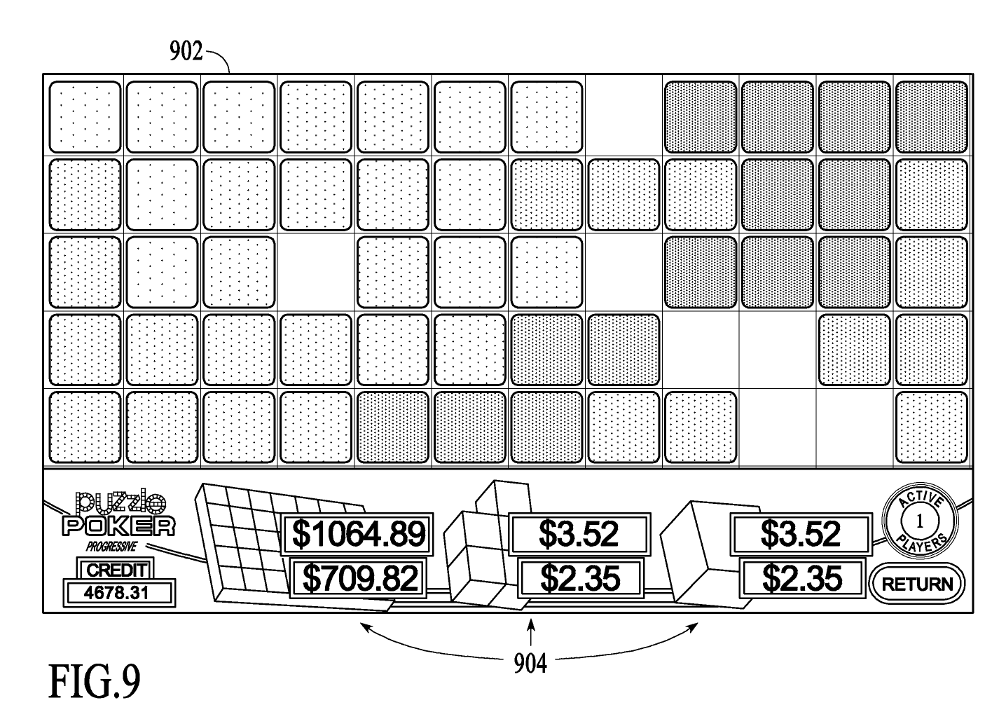

FIG. 9 illustrates the display of a community progressive puzzle game, under an embodiment. The community puzzle game of FIG. 9 is displayed on a common display that is viewable to all participating players at any time, such as on an overhead monitor mounted above or among an arrangement of personal game consoles, or it can be displayed as a window in the display of each game platform in a networked game environment. For the embodiment of FIG. 9, the community puzzle comprises an array of block spaces 902 that are filled one block at a time. This type of community game typically corresponds to the embodiment in which the individual bonus game is a puzzle solving game, such as shown in FIG. 4. When a player fills in his or her own puzzle of FIG. 4, one block is sent to the community puzzle.

In one embodiment, the community puzzle incorporates a progressive jackpot in which the highest payoff jackpot) has a value that increases by a small amount for every game played. The game platforms for each participating player are linked together to form one single progressive jackpot that grows relatively quickly because multiple players are contributing to the jackpot at the same time. As shown in FIG. 9, a common display area 904 shows certain parameters associated with the community game and the progressive jackpot. For example, the number of active players is displayed along with the value of the jackpot. In one embodiment, the jackpot is shared among all participating and qualified players. In this case, the display indicates the payout to the winning player and to each of the other players (shared amount). Further, jackpots can be awarded for different winning hands or actions.

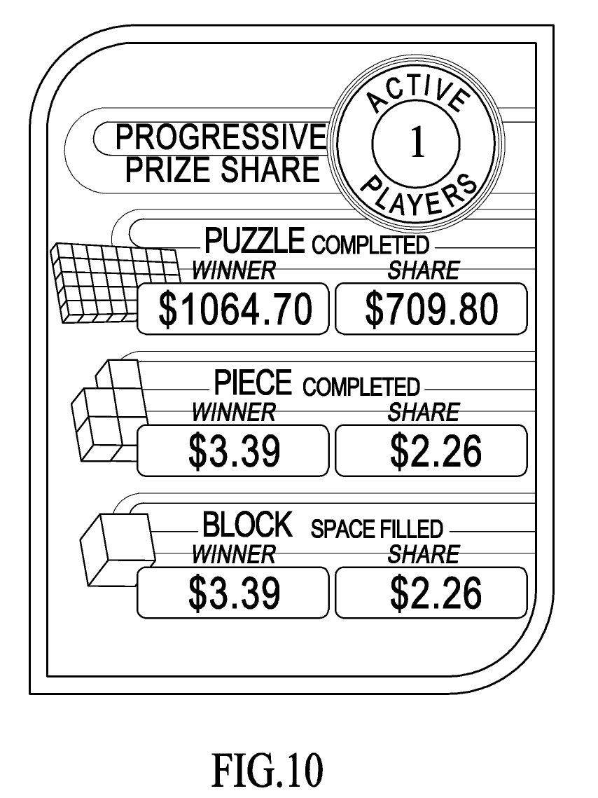

FIG. 10 illustrates the display of a shared progressive jackpot for a puzzle poker game, under an embodiment. For the example of FIG. 10, a player can win a progressive play by filling in an empty block of the community puzzle, completing a five-block piece in the community puzzle, or placing the last block in the puzzle. Thus, as shown in FIG. 10, the display area shows the winner and shared jackpots for each of completing the puzzle, completing a block, or filling a space. Through the shared jackpot or prize system, each player can receive a share of a prize when another player wins. The amount shared depends on the number of active players at the time of the win. Each share and jackpot is continually updated during play. The share diagram meter displays the prize distributions. In one embodiment, the distribution between the winner and the sharing players is 50-50, that is the winner receives 50% of the jackpot and the remaining players share the remaining 50% in equal amounts. Any other distribution can be possible, however, such as 60-40, 70-30, and so on. Furthermore, the shared distribution can be scaled depending upon the number of players, for example, 70-30 if there are less than 10 players and 50-50 if there are 10 players or more, and so on.

The shared display can be configured in any manner that clearly shows the relevant values, as well as attracts attention. For example, the amount of the jackpot can be shown on a meter as a money value, large bright numbers, flashing bars or other icons, or similar display elements. The progressive jackpot for the shared community game can also be displayed as a window in each individual player's game console, as shown in area 510 of FIG. 5.

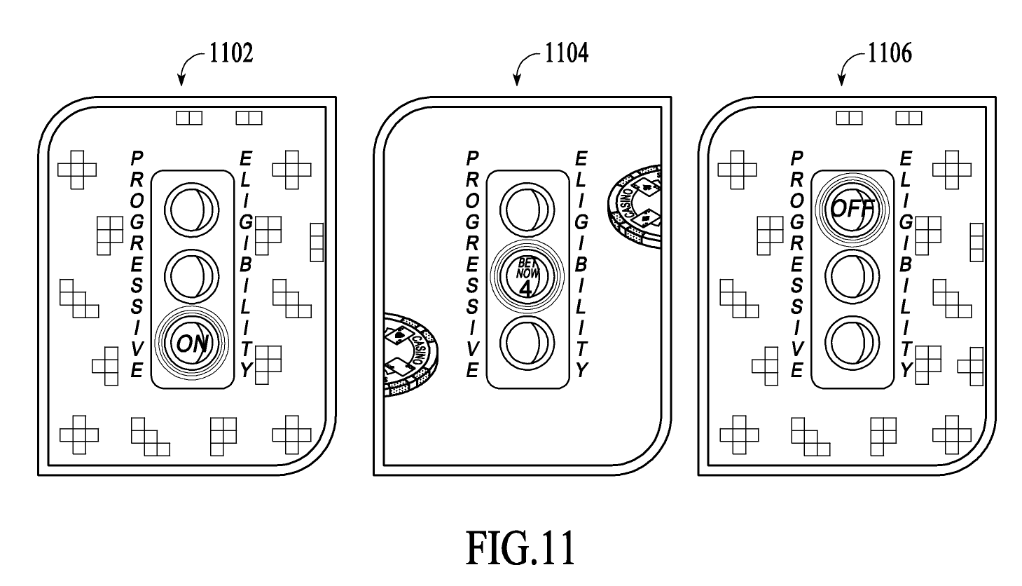

As with most progressive games, only players who are qualified to play can participate in the community progressive puzzle. This eliminates the possibility of players joining in opportunistically to reap a share of a winning without contributing to the pot or playing a minimum number of games. In general, only players who wager a predefined number of credits per play qualify to win the jackpot, and all wagers contribute to the jackpot. In one embodiment, to qualify for the community game, a player must place the bonus bet 201 through the poker game, FIG. 2. The player must consistently play a number of hands of poker. For example, the player must not let more than 20 seconds (or some similar period of time as defined by the system) elapse between hands. If the player allows this period of time to elapse, he or she is alerted that they are no longer qualified. The player then needs to play another had with the bonus bet enabled to qualify again. Because of the time nature of qualification, a suitable display is provided. FIG. 11 illustrates a qualification display screen for a community puzzle of a puzzle poker game, under an embodiment. As shown in FIG. 11, the qualification screen is shown as a traffic signal with red, yellow, and green lights. The green light shines 1102 when the player is qualified, the yellow light shines 1104 when the player has a limited amount of time (e.g., 10 or fewer seconds) to play a hand, and the red light shines 1106 when the player is not qualified. Alternatively, the qualification screen can be displayed as a bar code meter, temperature scale, hourglass, or any other display that indicates the passage of time or scaled measure. The qualification screen for the shared community game can also be displayed as a window in each individual player's game console, as shown in area 520 of FIG. 5.

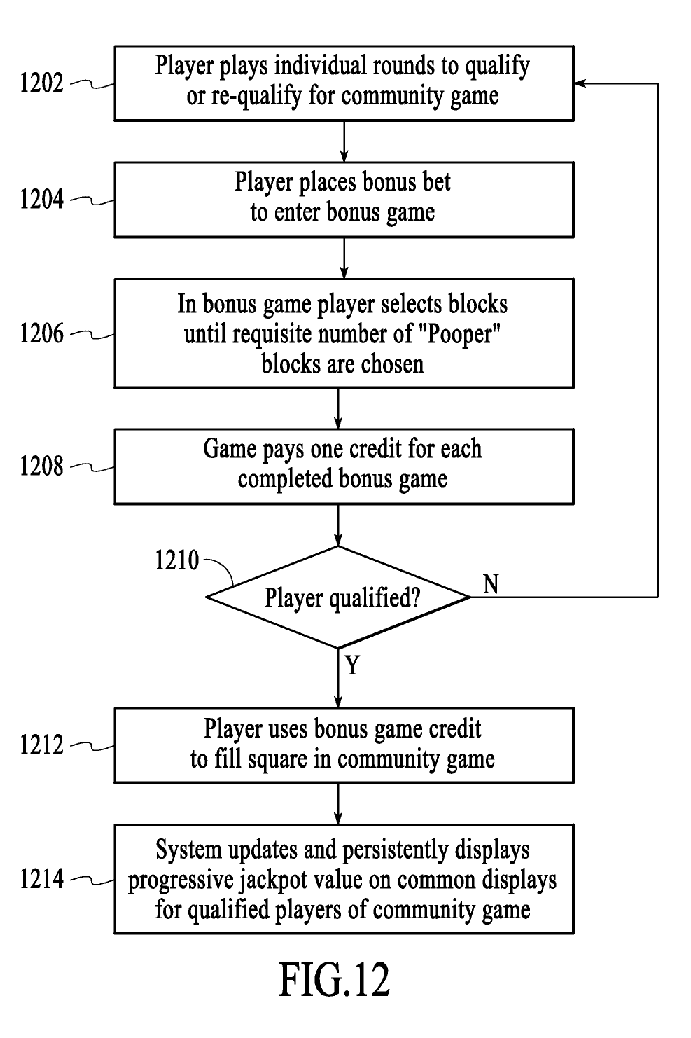

In one embodiment, the puzzle poker game consists of a number of individual poker hands followed by a bonus game round or rounds, and then participation in the community game. FIG. 12 is a flowchart that illustrates the process of participating in a community game, according to an embodiment. The process begins with the player playing a number of individual poker rounds on the game console, block 1202. If the user elects to participate in the community game, the user must complete a number of poker hands in accordance with the qualification requirements, e.g., play a certain number of hands during a defined time period. The player must also play a bonus game by entering a bonus bet, block 1204. The player may then play the bonus game, which for purposes of description will correspond to the bonus game illustrated in FIG. 3. For this embodiment, the player selects from a set of 60 squares of which 20 squares are “poopers”. The player continues picking pieces until 3 “poopers” have been chosen, block 1206. The non-pooper squares contain varying reward amounts. The game pays one credit for each bonus game 1208, though other credit payment schemes are also possible. In block 1210 it is determined whether the player is qualified. As shown in FIG. 11, this depends on the amount of time between the play of poker hands, as well as other possible defined criteria. If the player is not qualified, he or she may play poker hands to qualify or re-qualify, block 1202. If the player is qualified, the player uses the bonus game credit earned in block 1208 to fill a block in the community game, block 1212. In block 1214, the system updates and persistently displays the progressive jackpot value on a common display visible to all of the qualified participating users, or on the individual game console screens for these users, as illustrated in FIG. 5. The frequency of the persistent update can be defined by the system, and can typically vary from an update every second to every minute or five minutes, depending on the number of players and the rate of play.

Depending upon implementation, certain guidelines may be enforced. For an example implementation, such as for a casino, example guidelines for the bonus game include ensuring a payback of 100 percent of monies contributed to the community game progressives, such as, 80 percent of the money goes to the lower progressive and 20 percent goes toward the top, and one credit per play is contributed to the progressives. In this case, the odds of hitting a winning hand are 20.6%. The number of winning hands needed to fill the 12 piece puzzle is given by:

12 pieces/0.206 chance of getting a piece=58.25 plays to fill puzzle.

The number of credits amassed for lower progressive is given by:

1 Credit per play*0.80 credits=0.8 credits per play

0.8 credits per play*58.25 plays to fill puzzle=46.6 credits in final puzzle.

The average number of non-pooper picks is: 5.71 non-pooper picks.

The following algorithm illustrates a process of calculation to determine a pay of one credit for pooper picks:

Stealing a percentage from the poker game:
5 credits are played on each hand.
58.25 hands are played before the puzzle is completed
1 percent of 5 credits is 0.05 credits. 0.01*5=0.05 credits/play
Total credits added to the final puzzle: 0.05 credits/play*58.25 plays=2.912 credits added for every percent.
These 2.912 credits must be divided among the 5.72 non-pooper picks. 2.912 credits/5.72 non-pooper picks=0.509 credits extra per non-pooper pick.
Total extra credits to add to a pool of 1000 non-pooper pick possibilities: 1000*0.509=509 credits additional credits per percent.

For an 80/20 split, the algorithm is:

58.25 plays to fill puzzle*0.8 credits per play=46.864 credits in the final puzzle
5.72 non-pooper picks
46.864 total credits/5.72 non-pooper picks=8.18 credits per non-pooper pick
8.18 credits per non-pooper pick*1000 possible non-pooper picks=8180 credits

For an 80/20 split with three (3) Percent stolen from basic game and a pay of one credit per pooper pick, the algorithm is:

46.864 credits+(3 percent*2.912 credits/percent)=55.6 credits in final puzzle.
Subtract 3 credits for the 3 pooper picks. 55.6 credits−(1 credits/pooper pick*3 pooper pick)=52.6 credits.
52.6 credits/5.72 non-pooper picks=9.195 credits/non-pooper pick
Total credits in a pool of 1000 non-pooper picks: 1000 non-pooper picks*9.195 credits/non-pooper pick=9195 credits

For an 80/20 split and a pay of one credit per pooper pick, the algorithm is:

46.864 credits in final puzzle.
Subtract, 3 credits for the 3 pooper picks. 46.864 credits−(1 credits/pooper pick*3 pooper pick)=43.864 credits.
43.864 credits/5.72 non-pooper picks=7.66 credits/non-pooper pick
Total credits in a pool of 1000 non-pooper picks: 1000 non-pooper picks*7.66 credits/non-pooper pick=7660 credits

In a gaming environment, such as a casino, a preferred implementation may be to have a plurality of game consoles or kiosks arranged around a common big screen monitor so that a number of individual players, such as between six and twelve, play a number of poker and bonus games, and at least one community game per period of time. In one embodiment, in which the poker game is a traditional 5-card draw game and the qualification time limit is on the order of 20 seconds, and the community game implements algorithms such as illustrated above, the following deployment scenario may be achievable. A bonus game based on the 60 square pentiminos yields 1010 total puzzle combinations. It takes an average of 59 games to complete the puzzle and the average time to reach a bonus round is 10 minutes based on a bonus win as three pooper picks that pays one credit, and the chance that the player can win two credits to 1000 credits in one pick. There is an average of 280 bonus games needed to complete the progressive community game. Multiple players contribute to the progressive game, and the average progressive community jackpot yield is 815 credits. In this case, the progressive community game pays every eight hours, if there are six game consoles. This is meant only to provide a possible example of a deployment and the time values are merely illustrative of a possible gaming scenario. Such an example, however, shows that the puzzle poker system that incorporates a progressive community game provides a long-running game in which the jackpot constantly grows and can be shared among a number of users. The long duration for jackpot payout in the community game encourages multiple players to participate during the course of a typical eight hour play period.

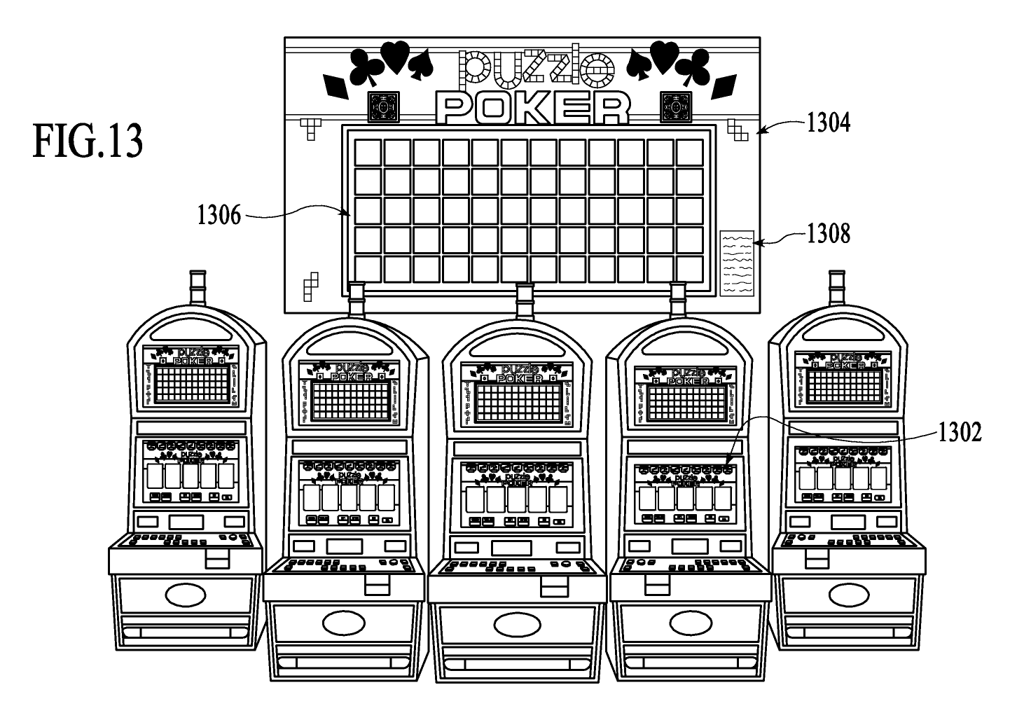

In one embodiment, the puzzle poker system is implemented in a kiosk or console-based system consisting of a number of individual game consoles connected to one another within an area such as a room or portion of a casino. For this embodiment, each game platform is an individual console that can accommodate a single player, each console has its own display, input/output or controller section, and money or chip slot, if necessary. A big-screen display is positioned in the region of the consoles to display the community game and the progressive jackpot values. FIG. 13 illustrates a console-based gaming system for implementing a community puzzle poker game, under an embodiment. As shown in FIG. 13, a number of individual game consoles 1302 are positioned in relatively close proximity to one another and networked together through appropriate electronic hardware. A common display screen 1304 of a sufficiently large size is positioned so that it is visible to all of the players of the individual consoles 1302. The common display screen 1304 includes a game area 1306 that displays the array for the community game, and a shared progressive jackpot area 1308 that displays the values and parameters related to the progressive jackpot.

In one embodiment, the puzzle poker game is executed as a server process that operates in a client-server system for a number of networked game consoles. For the embodiment of FIG. 13, one of the game consoles 1302 is configured as a server computer that executes the server-side puzzle poker game. Each of the other game consoles executes client-side version of the puzzle poker game. The server-side process is responsible for processing and displaying the community game and progressive jackpot data.

Besides the networked game console implementation of FIG. 13, the community puzzle poker game system can be implemented in an online or distributed computer network environment. In this implementation, the players need not be in close proximity with one another, but can instead play from a computer or processing device in their home or other remote location. For this embodiment, each remote game console executes a client side version of the puzzle poker game and one of the networked consoles is configured as a server. For this embodiment, each game console is has its own display that includes a window for the individual puzzle poker game and a separate window for the community game. The server-configured client computer hosts the community game and coordinates the display of the community game and progressive jackpot data on each other game console computer. Alternatively, each of the game consoles executes a standalone version of the puzzle poker game. In this configuration, the community game and progressive jackpot are synchronized through a common synchronization process. The network coupling the game consoles can be a wide area network (WAN), a local area network (LAN), the Internet, or any other network via which the electronic puzzle poker game data can be efficiently transferred.

The game consoles for the networked embodiments can be implemented as video poker machines that include display devices or monitors that display the game according to embodiments. The video poker machines also include a processor as known in the art. The video poker machines also include input and output devices for receiving input from a player and generating appropriate output. For example, input devices include buttons for the player to push, and a touch screen the player can touch to select and/or move items displayed. Output devices include the monitor and speakers for outputting audio information and sound effects.

The game console environment of FIG. 13 can be provided in a casino licensed to accept wagers and pay bets. Alternatively, the venue can be a private home that purchase the electronic video poker game and play the game privately. In yet another alternative, the venues can be an establishment that provides the electronic video poker game to patrons who do not wager real money when playing the game. Several other alternatives are also possible.

Aspects of the one or more embodiments described herein may be implemented on one or more computers, game platforms, or computing devices executing software instructions. The computers may be networked in a client-server arrangement or similar distributed computer network. In one embodiment, the puzzle poker system may be implemented in a World-Wide Web (WWW) environment in which a server or server clustering environment stores data in the form of web pages and transmits these pages as Hypertext Markup Language (HTML) files over the Internet to the client computers. For this embodiment, the client computers typically run a web browser program to access the web pages served by server computer and any available content provider or supplemental server.

The network client computers are configured to run a client-side process that implements embodiments of the puzzle poker game program. The client computer may be any type of suitable computing device, such as a game kiosk or console, personal computer, workstation computer, notebook computer, personal digital assistant (PDA), mobile phone, smartphone, or any similar class of mobile computing device with sufficient processing, communication, and audio/video playback capability. For the networked embodiments, any of the processes executed on any of the client and/or server computers may be standalone programs executed locally on the respective client computer, or they can be portions of a distributed client application run on the client or a network of client computers. Such programs may also be referred to by other terms, such as “module,” “component,” and “process,” which may be used interchangeably to mean an computer program, routine, or subroutine that is executed on any of the server and/or client computers, and may be implemented as software, firmware, or programmed hardware.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other systems and methods for video card games, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all systems and methods that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. An online game system comprising:
a plurality of networked game consoles each executing a progressive community game allowing participation of a player against other participating players, each player of the participating players operating an individual respective game console;
a progressive community jackpot process managing data related to the total amount of the jackpot and the value of each share in the jackpot; and
a common display visible to the participating players and configured to display a current value of the total amount of the jackpot and the current value of each share in the jackpot.

2. The online game system of claim 1 wherein the jackpot is a progressive jackpot that increases as the number of participating players increases.

3. The online game system of claim 2 wherein the progressive jackpot is shared among the participating players in a predefined split upon the occurrence of a payout event.

4. The online game system of claim 3 further comprising an update process configured to update the progressive jackpot periodically on a periodic basis.

5. The online game system of claim 4 wherein the periodic basis is selected from the group consisting of: at least one update every second, at least one update every 30 seconds, at least one update every minute, at least one update every two minutes, and at least one update every five minutes.

6. The online game system of claim 5 wherein the community game comprises an online poker game, and wherein the poker game is one of five-card draw or seven-card draw poker.

7. The online game system of claim 5 wherein the community game comprises a bonus game for an online poker game, the bonus game comprising filling in a multi-square array with blocks, and wherein the blocks are placed in the array upon successful playing of one or more hands of the online poker game.

8. The online game system of claim 7 wherein at least a portion of the jackpot is paid out upon the payout event, and wherein the payout event comprises one of placement of a block in the array, completion of a defined shape caused by placement of a final block within the shape, or completion of the array with placement of a full number of blocks.

9. The online game system of claim 1 wherein the networked game consoles comprise game kiosks coupled to one another in a defined area, and wherein the common display comprises a big screen monitor placed in proximity to the game kiosks and positioned so as to be visible to all participating players.

10. The online game system of claim 8 wherein the networked game consoles are located in an area of a casino.

11. The online game system of claim 1 wherein the networked game consoles comprise networked computers placed at remote locations relative to one another, and wherein the common display comprises a window within each display device coupled to a respective networked computer.

12. The online game system of claim 11 wherein the networked computers are coupled to one another over the Internet, and wherein the community game is played over through a web browser running on each networked computer.

13. A method comprising:
executing a community game on a plurality of networked game consoles, each game console operated by a separate player, the community game including a progressive jackpot that increases as the number of participating players increases;
updating the progressive jackpot periodically on a period not exceeding one minute;
displaying a total jackpot amount and a share amount for each participating player on a display visible to all of the participating players; and
updating the displayed amounts continuously as the progressive jackpot is updated.

14. The method of claim 13 wherein the progressive jackpot is shared among the participating players in a predefined split upon the occurrence of a payout event, and wherein the payout event is related to an event in the community game or an individual game played by a participating player on a respective game console.

15. The method of claim 14 wherein the community game is a bonus game for an individual poker game played by each participating player on their respective game consoles.

16. The method of claim 13 wherein at least a portion of the progressive jackpot is paid out upon the occurrence of one of three possible events, and wherein the progressive jackpot displayed as the winners share and shared amount for each event of the three possible events.

17. The method of claim 16 wherein the winners share is 50 percent and each of the remaining participating players equally share the remaining 50 percent.

18. A display device comprising:
a first display area displaying the total current amount of the winner's share of a progressive community jackpot; and
a second display area displaying the total current amount of each non-winning participating player's share of the progressive community jackpot, wherein the community jackpot is paid out upon the occurrence of an event in a community game played by participating players through respective game consoles that are positioned within a viewing radius of the display device.

19. The display device of claim 18 wherein the progressive community jackpot increases as the number of participating players increases, and further wherein the progressive jackpot is shared among the participating players in a predefined split upon the occurrence of a payout event.

20. The display device of claim 19 wherein an update process updates the first display area and second display area continuously on a periodic basis, and wherein the periodic basis is selected from the group consisting of: at least one update every second, at least one update every 30 seconds, at least one update every minute, at least one update every two minutes, and at least one update every five minutes.
